(19) United States
(12) Patent Application Publication
(10) Pub. No.: US 2010/0058194 A1
(43) Pub. Date: Mar. 4, 2010

(54) Remote Desktop on Multi-Function Peripheral

(76) Inventor: James E. Owen, Vancouver, WA (US)

Correspondence Address: MICHAEL BLAINE BROOKS, PC, P.O. BOX 1630, SIMI VALLEY, CA, 93062-1630, US

(21) Appl. No.: 12/202,021

(22) Filed: Aug. 29, 2008

(51) Int. Cl. G06F 3/048; G06F 15/16

(52) U.S. Cl. 715/740; 709/203

(57) ABSTRACT

Systems, devices, methods, and computer-readable media for executing the remote access via an MFP of one or more computing devices in a network of computing devices originating jobs for the MFP based on a database comprising the IP address and password for each job-originating computing device logged into the network.

### FIELD OF ENDEAVOR

The present invention in its several embodiments relates generally to remote access of a computing device in a networked environment, and more particularly to remote access of a computing device from a multi-function peripheral device in a networked environment.

### BACKGROUND

In a computer networked environment, a first computing device may host a virtual network computing server and a second computing device may host a virtual network computing client where the client may access and control the desktop of the server. A multi-function peripheral (MFP) device is used to print and fax information from a computing device in communication, e.g., networked, with the MFP device. An MFP device may be configured additionally to scan sheets of documents and transmit the scanned sheets, in electronic form, to a computing devices. In computing networks where the computing devices are personal computers (PCs), an MFP device is not configured as a peer of the PCs, rather they are configured as peripheral equipment having capabilities generally limited to input and output of paper. Accordingly, the typical interaction of the computing device with the MFP device requires the user executing one or more steps at the computing device to cause the MFP device to print a job. In addition, the typical scanning operation requires the user executing one or more steps at the MFP device to direct the MFP device to send the scanned information to a particular computing device.

Where a computing device has merely logged onto a network having an MFP device, the user is unable to initiate at the MFP device a print job from the merely logged on computing device and the user is unable to view at the MFP device a scanned document file as received by the computing device. In addition, where a single user is responsible for secure printing of a file at a remote MFP device, more than a single trip from the source or file-originating computing device to the secure MFP device may be required especially in the case of reprinting. The network architecture may have an MFP device in a locked room separate from the file-originating computing device. In addition, the MFP device may be configured to support security measures such as printing responsive to the input of a personal identification number (PIN).

### SUMMARY

The present invention may be embodied as systems, devices, methods, and computer-readable media for executing the remote access via an MFP device of one or more computing devices in a network of computing devices originating jobs for the MFP device based on a database comprising the IP address and password for each job-originating computing device logged into the network. For example, a multi-function peripheral device embodiment may comprise: a processing unit, addressable memory, and a user interface having a display; wherein the processing unit is configured to execute instructions, not necessarily in the following order, comprising: (a) identify, via the user interface, a first computing device logged onto the network of the MFP device, i.e. made available for remote device access via a network link; (b) initiate, via the user interface, a virtual desktop session with the first computing device; and (c) transmit a multi-function peripheral job instruction to the first computing device within the virtual desktop session. In some embodiments, the processing unit may be further configured to obtain an identifying element of the first remote computing device, i.e., the first remote computing device, from a second computing device and/or configured to obtain an identifying element of the first remote computing device from a second computing device based on a user-provided identifying element. For some embodiments, the processing unit may be further configured to obtain an identifying element of the first remote computing device from a second computing device based on a user-provided personal identification number. Also for some embodiment, the processing unit may be further configured to receive the multi-function peripheral job from the first computing device according to the transmitted job instruction.

The present invention may be embodied as a process. For example, embodiment of the present invention includes a machine-enabled method of job manipulation at a job source computing device via a user interface of a multi-function peripheral (MFP) device comprising a processing unit and addressable memory and a display, the method comprising steps, not necessarily in the following order, of: (a) identifying, via the user interface, a first computing device in networked communication with the MFP device, i.e., made available for remote device access via a network link, e.g., logged onto the same network as the MFP device; (b) initiating, via the user interface, a virtual desktop session with the job source computing device; and (c) transmitting a multi-function peripheral job instruction to the job source computing device within the virtual desktop session. Some embodiments as a machine-enabled method may further comprise obtaining an identifying element of the first remote computing device from a second computing device. Other embodiments such as a machine-enabled method may further comprise obtaining an identifying element of the first remote computing device from a second computing device based on a user-provided identifying element. Also, some embodiments as a machine-enabled method may further comprise obtaining an identifying element of the first remote computing device from a second computing device based on a user-provided personal identification number and embodiments as a machine-enabled method may further comprise receiving the multi-function peripheral job from the first computing device according to the transmitted job instruction.

Embodiments of the present invention may be present in a medium such as a DVD, a CD, or a portable flash memory device. Accordingly, embodiments of the invention may include a computer-readable medium having computer-executable instructions stored thereon which, when executed by a multi-function peripheral, are operative to cause the computer to: (a) identify, via the user interface, a first computing device in networked communication with the MFP device, i.e., made available for remote device access via a network link, e.g., logged onto the same network as the MFP device; (b) initiate, via the user interface, a virtual desktop session with the first computing device; and (c) transmit a multi-function peripheral job instruction to the first computing device within the virtual desktop session. The computer-readable medium may also have computer-executable instructions stored thereon which, when executed by a computer, are operative to cause the computer to obtain an identifying element of the first computing device from a second computing device. The computer-readable medium may also have as an option computer-executable instructions stored thereon which, when executed by a computer, are operative to cause the computer to obtain an identifying element of the first computing device from a second computing device. The computer-readable medium may also have computer-executable instructions stored thereon which, when executed by a computer, are operative to cause the computer to obtain an identifying element of the first computing device from a second computing device based on a user-provided identifying element. The computer-readable medium may also comprise computer-executable instructions stored thereon which, when executed by a computer, are operative to cause the computer to obtain an identifying element of the first computing device from a second computing device based on a user-provided personal identification number. The computer-readable medium may further comprise computer-executable instructions stored thereon which, when executed by a computer, are operative to cause the computer to receive the multi-function peripheral job from the first computing device according to the transmitted job instruction.

### BRIEF DESCRIPTION OF THE DRAWINGS

Embodiments of the present invention are illustrated by way of example and not limitation in the figures of the accompanying drawings, and in which:

FIG. 1 is an exemplary network diagram of an embodiment of the present invention;

FIG. 2 is an exemplary functional block diagram of an embodiment of the present invention;

FIG. 3 is a flowchart of an exemplary process embodiment of the present invention; and

FIG. 4 is a block diagram of an exemplary system of the present invention.

### DETAILED DESCRIPTION

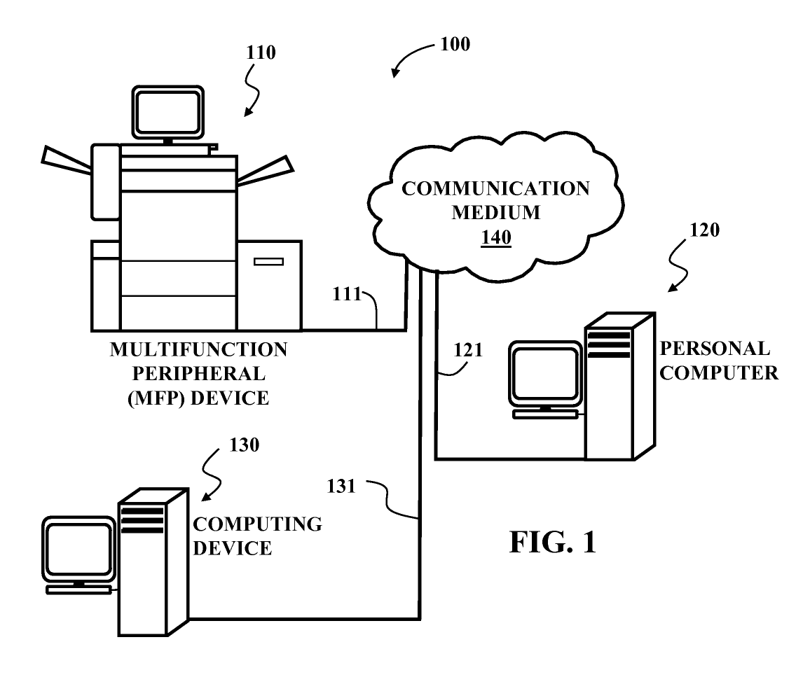

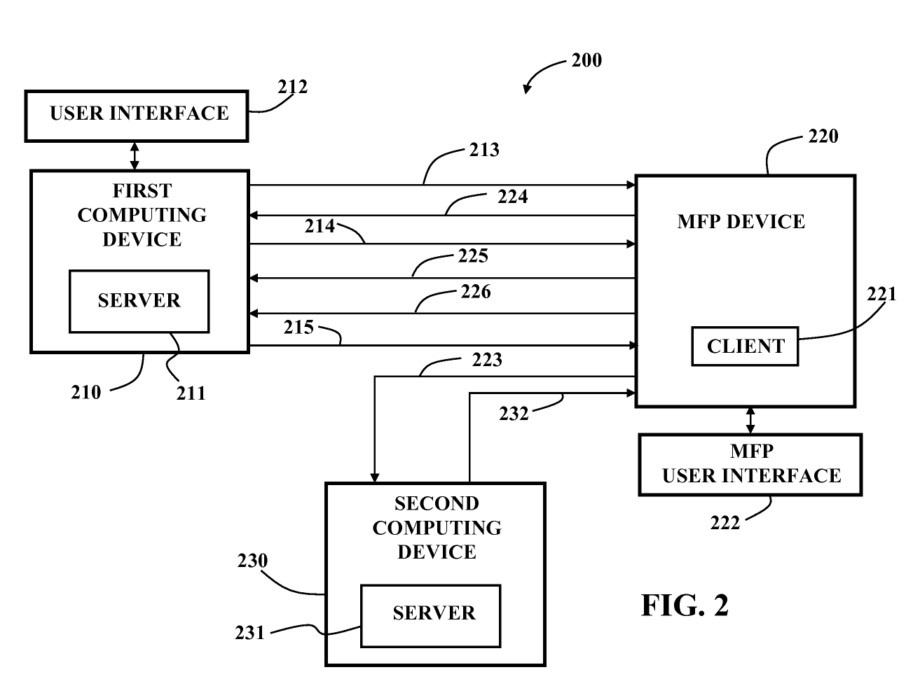

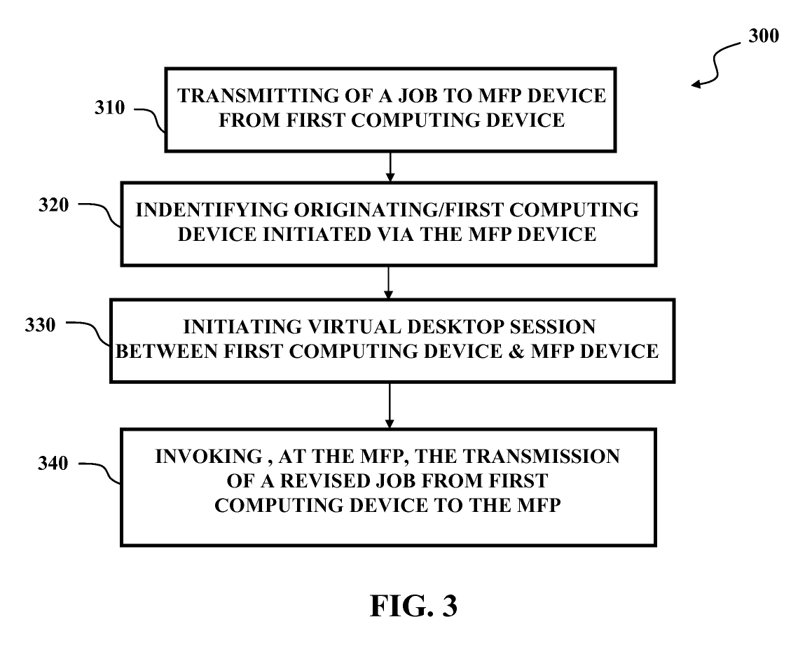

FIG. 1 illustrates an exemplary system embodiment 100 of the present invention where a multifunction peripheral (MFP) device 110 has a network link 111, a computing device shown as a personal computer 120 has a network link 121 and a computing device 130 having a network link 131 are in operable communication via a communication medium 140 such as a local area network or the internet. The network links 111, 121, 131 may comprise of multiple links and may include wireless communication links and wire and fiber optic communication links. An exemplary process may be illustrated both in a functional block diagram of FIG. 2 and a flowchart of FIG. 3. Referring to FIG. 2, in a computer networked environment 200, a first computing device 210 may host a virtual network computing server 211 and another computing device is shown as a multi-function peripheral (MFP) device 220 that may host a virtual network computing client 221 where the client may access and control the desktop portion of the operating system of the server 211. Across the exemplary system of FIG. 2, an exemplary process 300 may be executed as illustrated by the flowchart of FIG. 3 where there is a transmitting of a job to the MFP device from the first computing device (step 310). If the user at the MFP device wishes the job or a variation of the job resent to the MFP device, then, depending on the status of the job at the MFP device, identifying the computing device originating the job of interest to the user may be initiated at the MFP device (step 320). The user need not establish a remote access session between the first computing device and the MFP device, but the first computing device is preferably made available for remote device access via a network link, e.g., logged onto the network of, the MFP device. Accordingly, alternative embodiments of the exemplary process start at step 320, where for example, the user may wish to initiate an MFP job be sent from a first computing device to the MFP device for the first time, or irrespective, or previous communications from the first computing device to the MFP device. Once the computing device in both exemplary cases is identified, the exemplary process continues by initiating a virtual desktop session, or an equivalent session based on the operating system (OS), between the first computing device and the MFP (step 330) that may include a transmission of a password associated with the IP address of the first computing device. Invoking the transmission (step 340) of the same or a revised job, e.g. a print job, from the first computing device to the MFP may terminate the virtual desktop session.

Returning to the exemplary system of FIG. 2, a first user may initiate a subprocess via a user interface 212 where the first computing device, responsive to the user input, sends a job, e.g., a print job 213, to the MFP device 220. At the MFP device, the first user or a second user may initiate a subprocess via the MFP user interface 222 to locate, e.g., determine the IP address, of the first computing device 210 in the network 200. The exemplary system embodiment of FIG. 2 shows a query 223 sent from the MFP device 220 to a second computing device 230 hosting a server 231 that provides 232 the one or more computing devices presently logged into the network along with their respective IP addresses. The user at the MFP user interface 222 may select the first computing device and enter a password that is then sent 224 to the first computing device 210 in order to invoke the server 211 hosted by the first computing device to serve a virtual desktop 214 of the desktop of the operating system of the first computing device 210. Via the served virtual desktop 214, the user at the MFP user interface 222 may modify the job settings of a job 225, e.g., the most recent job sent to the MFP device 220 from the first computing device 210, and request 226 to be served the modified job, e.g., a modified print job. The server 211 of the first computing device 210 may then send to the MFP device 220 the modified job 215.

In some embodiments of the exemplary system embodiment of FIG. 2, a user's personal identification number (PIN) may, for a portion of the query 223, be sent from the MFP device 220 to the second computing device 230 hosting a server 231 that provides 232 the one or more computing devices presently logged into the network along with their respective IP addresses. The second computing device 230 may associate the PIN with the both the IP address and the password for the first computing device 210. In some embodiments, the database associating PIN with IP address and password may be hosted at the MFP device.

Embodiments of the present invention may include a client node and a server node where at each node sufficient computer instructions are present to support access to a first computing node via a second computing node, i.e., remote access. Remote access software for such networks may be obtained from REALVNC™ by RealVNC Ltd and via the Remote Desktop Protocol of MICROSOFT™ WINDOWS™. A user of the server hosting a server version of remote access software may access the server via the user interface of a client hosting a client version of the remote access software. For example, a unique personal identification number (PIN) may be associated with the IP address of the server and a password allowing access to the server via a remote access interface provided by the remote access software. By inputting the PIN via the client user interface, the user may control the desktop of the server. The PIN may be input manually via a touch screen or a keyboard or via a proximity device, such as a radio frequency identification (RFID) tag or transponder like a proximity badge. Accordingly, a user may initiate a first print or may re-print a document with the corrected settings via the MFP device.

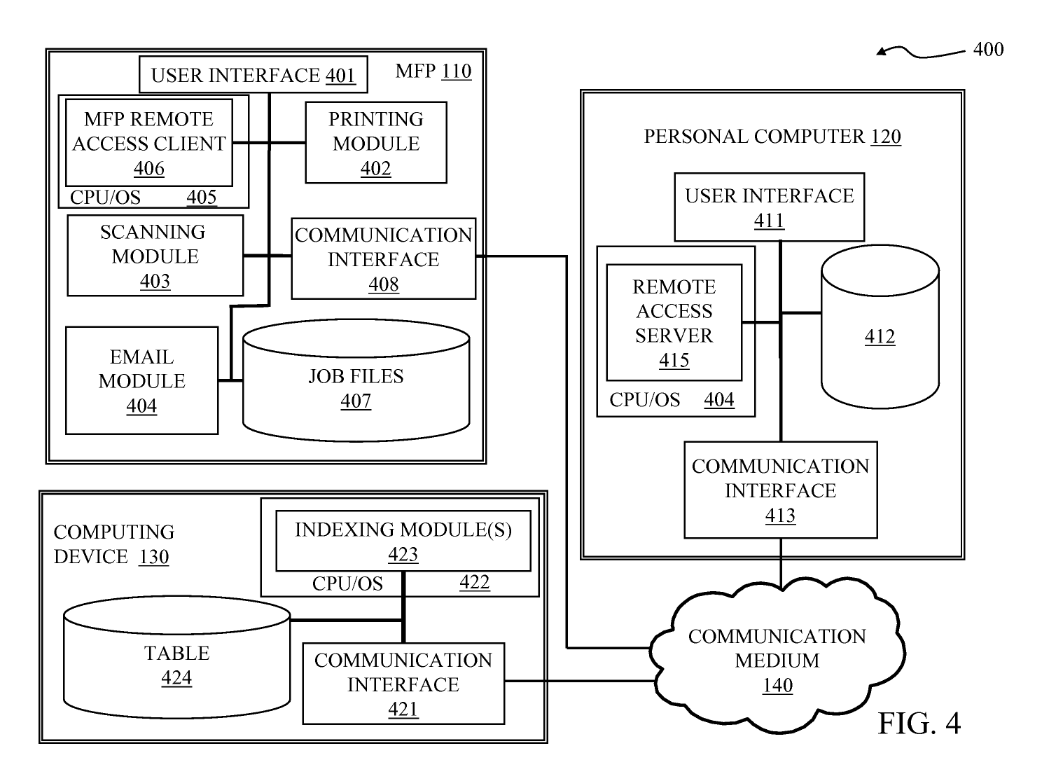

FIG. 4 illustrates an exemplary embodiment of FIG. 1 in greater detail where the networked system 400 comprises the MFP device 110, the personal computer 120 and the computing device 130 networked via the communication medium 140. As an exemplary client node, the MFP device 110 is illustrated as having a user interface 401, a printing module 402, a scanning module 403, an e-mail module 404, a central processing unit (CPU) 405 having an operating system (OS) configured to host the MFP remote access client 406. A data store 407 may be present to store the one or more job files generated at the MFP device 110 or received via the communication interface 408. As an exemplary server node, the personal computer 120 is illustrated as having a user interface 411, a data store 412, a communication interface 413, a CPU 404 having an OS configured to host a remote access server. As an optional exemplary server node, the computing device 130 is illustrated as having a communication interface 421, a CPU 422 having an OS configured to host a server and one or more indexing modules 423 configured to access a data store 424, e.g. storing a table, to serve computing node IP addresses and/or passwords for remote access to computing nodes responsive to one or more communications from the MFP device 110.

A user interface of FIG. 4 has at least one user interface element. Examples of user interface elements comprise input devices including manual input such as buttons, dials, keyboards, touch pads, touch screens, mouse and wheel related devices and voice and line-of-sight interpreters. Additional examples of user interface elements comprise output devices including displays, tactile feedback devices and auditory devices. An MFP display may be large enough for a user to visualize a portion of the desktop of a server node, i.e., the identified personal computer, and MFP display may be configured to support scrolling to display additional portions of the desktop of the server node.

In some embodiments of the user interface of the MFP device, a display may output a set of the most recent jobs printed by, identifying them by print job names, for example. The processing of the MFP device may be configured to receive a selection by the user of one of these displayed jobs and a user-provided password. Responsive to the input of job name and password, the MFP device may then establish a remote desktop session with the IP address associated with the selected print job. In another embodiment, the printer driver at the first computing device as the source computing node, may embed its name, i.e., the computer name, into the print job. So, rather than outputting to a display the print job name of each of the most recent print jobs, the MFP device may display the computer name for each the most recent print jobs. Thereafter, the user may select the displayed computer name of choice and with a password or pin, may initiate a remote access of the selected computer from the MFP device.

The scanning of IP networks for NetBIOS name information may be embodied via NBTScan available at http://www.inetcat.net/software/nbtscan.html. The finding of computers logged into the system may be embodied via the User Locator by Motivate Systems™.

Based on the foregoing, it should be appreciated that provided herein are systems, devices, methods, and computer-readable media for executing the remote access via an MFP device of one or more computing devices in a network of computing devices originating jobs for the MFP device based on a database comprising the IP address and password for each job-originating computing device logged into the network. One of ordinary skill in the art will also appreciate that the modules and functions described herein may be further subdivided, combined, and/or varied and yet still be in the spirit of the embodiments of the invention. In addition, while a number of variations of the invention have been shown and described in detail, other modifications, which are within the scope of this invention, will be readily apparent to those of ordinary skill in the art based upon this disclosure, e.g., the exemplary flowcharts or processes described herein may be modified and varied and yet still be in the spirit of the invention. It is also contemplated that various combinations or subcombinations of the specific features and aspects of the embodiments may be made and still fall within the scope of the invention. Accordingly, it should be understood that various features and aspects of the disclosed embodiments can be combined with or substituted for one another in order to form varying modes of the disclosed invention. Thus, it is intended that the scope of the present invention herein disclosed should not be limited by the particular disclosed embodiments described above.

What is claimed is:

1. A multi-function peripheral device comprising:
a processing unit, addressable memory, and a user interface including a display;
wherein the processing unit is configured to execute instructions comprising:
identify, via the user interface, a first computing device, made available for remote device access via a network link;
initiate, via the user interface, a virtual desktop session with the first computing device; and
transmit a multi-function peripheral job instruction to the first computing device within the virtual desktop session.

2. The computing device of claim 1 wherein the processing unit is further configured to obtain an identifying element of the first remote computing device from a second computing device.

3. The computing device of claim 1 wherein the processing unit is further configured to obtain an identifying element of the first remote computing device from a second computing device based on a user-provided identifying element.

4. The computing device of claim 1 wherein the processing unit is further configured to obtain an identifying element of the first remote computing device from a second computing device based on a user-provided personal identification number.

5. The computing device of claim 1 wherein the processing unit is further configured to receive the multi-function peripheral job from the first computing device according to the transmitted job instruction.

6. A machine-enabled method of job manipulation at a job source computing device via a user interface, of a multi-function peripheral device comprising a processing unit and addressable memory and a display, the method comprising:
identifying, via the user interface, a first computing device made available for remote device access via a network link;
initiating, via the user interface, a virtual desktop session with the job source computing device; and
transmitting a multi-function peripheral job instruction to the job source computing device within the virtual desktop session.

7. The machine-enabled method of claim 6 further comprising obtaining an identifying element of the first remote computing device from a second computing device.

8. The machine-enabled method of claim 6 further comprising obtaining an identifying element of the first remote computing device from a second computing device based on a user-provided identifying element.

9. The machine-enabled method of claim 6 further comprising obtaining an identifying element of the first remote computing device from a second computing device based on a user-provided personal identification number.

10. The machine-enabled method of claim 6 further comprising receiving the multi-function peripheral job from the first computing device according to the transmitted job instruction.

11. A computer-readable medium having computer-executable instructions stored thereon which, when executed by a multifunction peripheral device having a user interface and a display, are operative to cause the computer to:
identify, via the user interface, a first computing device made available for remote device access via a network link;
initiate, via the user interface, a virtual desktop session with the first computing device; and
transmit a multi-function peripheral job instruction to the first computing device within the virtual desktop session.

12. The computer-readable medium of claim 11 further having computer-executable instructions stored thereon which, when executed by the multifunction peripheral device, are operative to cause the multifunction peripheral device to obtain an identifying element of the first computing device from a second computing device.

13. The computer-readable medium of claim 11 further having computer-executable instructions stored thereon which, when executed by the multifunction peripheral device, are operative to cause the multifunction peripheral device to obtain an identifying element of the first computing device from a second computing device.

14. The computer-readable medium of claim 11 further having computer-executable instructions stored thereon which, when executed by the multifunction peripheral device, are operative to cause the multifunction peripheral device to obtain an identifying element of the first computing device from a second computing device based on a user-provided identifying element.

15. The computer-readable medium of claim 11 further having computer-executable instructions stored thereon which, when executed by the multifunction peripheral device, are operative to cause the multifunction peripheral device to obtain an identifying element of the first computing device from a second computing device based on a user-provided personal identification number.

16. The computer-readable medium of claim 11 further having computer-executable instructions stored thereon which, when executed by the multifunction peripheral device, are operative to cause the multifunction peripheral device to receive the multi-function peripheral job from the first computing device according to the transmitted job instruction.
